(19) United States
(12) Patent Application Publication
(10) Pub. No.: US 2009/0243355 A1
(43) Pub. Date: Oct. 1, 2009

(54) CRASH-ACTIVE SYSTEM OF A VEHICLE

(76) Inventors: Norbert Heeg, Dahn (DE); Wladimir Steinmetz, Rockenhausen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/295,316

(22) PCT Filed: Oct. 1, 2007
(86) PCT No.: PCT/EP07/08504

§ 371 Date: Apr. 23, 2009

(30) Foreign Application Priority Data
Nov. 21, 2006 (DE) 10 2006 055 185.0

(51) Int. Cl. B60N 2/427

(52) U.S. Cl. 297/216.12; 297/216.1

(57) ABSTRACT

In the case of a crash-active system of a vehicle, in particular of a vehicle seat, with a support (5), an impact element (11) which is arranged on said support (5) in a manner such that it is movable relative thereto, in particular is coupled to the support (5) by means of at least one four-bar linkage (14), a drive (15) by means of which the impact element (11) can be extended, at least in the event of a crash, from a starting position in the vicinity of the support (5) into a protective position which, in particular, is placed closer to the occupant, and a latch (21) which normally locks the drive (15) to the support (5), the latch (21) is mounted on the support in a floating manner.

### CROSS REFERENCE TO RELATED APPLICATIONS

This application is a United States National Phase application of International Application PCT/EP2007/008504 and claims the benefit of priority under 35 U.S.C. § 119 of German patent application DE 10 2006 055 185.0 filed Nov. 21, 2006, the entire contents of which are incorporated herein by reference.

### FIELD OF THE INVENTION

The present invention pertains to a crash-active system.

### BACKGROUND OF THE INVENTION

U.S. Pat. No. 7,070,235 B2 discloses a crash-active system of this type, which system is designed as a head restraint and uses numerous components to implement numerous functions, for example, apart from the crash activity, also an adjustment of the comfort and a resetting of the head restraint, which takes place by means of a tool introduced from the outside. A double leg spring which is held by means of a mechanism, which has a latch, of a magnet unit serves as a drive.

### SUMMARY OF THE INVENTION

The invention is based on the object of simplifying a crash-active system of the type mentioned at the beginning.

Owing to the fact that the latch is mounted on the support in a floating manner, the forces acting on the latch can exert different moments—as a function of the position of the latch relative to its bearing. In order to lock the drive to the support, the latch receives the drive, or more precisely part of the drive. In addition to the possibility of the latch being of concave design and the received drive being of convex design, this is intended to be understood as also meaning the design the other way around. The bearing of the latch on the support comprises, for example, a bearing pin, which is also intended to be understood as including material projections or other convex formations on the latch or on the support, and an elongated hole, which is also to be understood as including other receptacles or other concave formations on the latch or on the support that receive the bearing pin or the like with (a large amount of) play. For example, the elongated hole is assigned to the latch and the bearing pin is assigned to the support, with the kinematically reverse arrangement likewise being possible. The bearing is produced in such a manner that it provides at least two spaced-apart relative positions of latch and support, between which the latch floats, i.e. passes by means of a displacement which may also be a rotation about an axis placed outside the bearing, or a combination of a plurality of movements.

The drive normally preferably exerts a closing moment, if any moment at all, on the latch such that no particular holding devices with mechanisms for transmitting the holding force are required in order to hold the latch in such a locking starting position. If there is a resetting spring or the like for the latch, said resetting spring exerting a closing moment on the latch, the drive, in a modified embodiment, can exert an opening moment which is smaller by comparison. In the event of a crash or another triggering situation, for example pre-crash situation, the latch which is mounted in a floating manner is preferably moved, for example displaced—relative to that part of the bearing which is assigned to the support—into a position in which the drive exerts an opening moment on the latch such that the latter can pivot up and release the drive. In the triggering situation, the latch can also be pivoted up directly, in particular about the drive, which is received by the latch, as the axis of rotation. The movement of the latch in the triggering situation, i.e. in particular the displacement or pivoting up, preferably takes place by means of an actuator which can normally support the latch or is spaced apart slightly therefrom, and preferably has an extendable part, for example a piston. “Slightly” is to be understood as meaning in relation to the path covered by the extending part or to the dimensioning of the elongated hole.

By means of optimized geometries, for example of the latch in the region of a hook mouth for receiving the drive or at the contact surface with the actuator, the insensitivity of the system to tolerances which originate from the spring and/or the manufacturing of the components can be increased.

A resetting spring which is preferably provided can exert a closing moment on the latch, for example can prestress it with regard to a rotation about the bearing pin toward the support, and/or can prestress the floatingly mounted latch with respect to a certain relative position of latch and support, for example can prestress the bearing pin toward one end of the elongated hole or the latch toward the actuator. Both functions can be realized in a single resetting spring with different legs and coils.

The crash-active system may be, for example, a crash-active head restraint of a vehicle seat such that the latch designed according to the invention locks the drive of said head restraint. However, the use is not restricted thereto but rather may involve all crash-active systems of a vehicle, in which a drive for moving an impact element is held by a latch. Thus, a design as a crash-active antisubmarining ramp, as disclosed, for example, in DE 103 40 996 A1, or as a crash-active engine hood for protection of pedestrians, is also conceivable.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partial view of a head restraint according to the invention in the normal situation with a locking latch according to a first exemplary embodiment;

FIG. 2 is a partial view corresponding to FIG. 1 with the latch displaced in the triggering situation;

FIG. 3 is a partial view corresponding to FIGS. 1 and 2 with the latch pivoted up;

FIG. 4 is a schematic view of a vehicle seat with the head restraint according to the invention in the normal situation;

FIG. 5 is a schematic view corresponding to FIG. 4 showing the triggered head restraint after a crash;

FIG. 6 is a perspective partial view of a head restraint according to the invention in the normal situation with a locking latch according to a second exemplary embodiment;

FIG. 7 is a partial right side view corresponding to FIG. 6; and

FIG. 8 is a partial left side view corresponding to FIGS. 6 and 7 with the latch pivoted up and the drive released and moving out.

### DESCRIPTION OF THE PREFERRED EMBODIMENTS

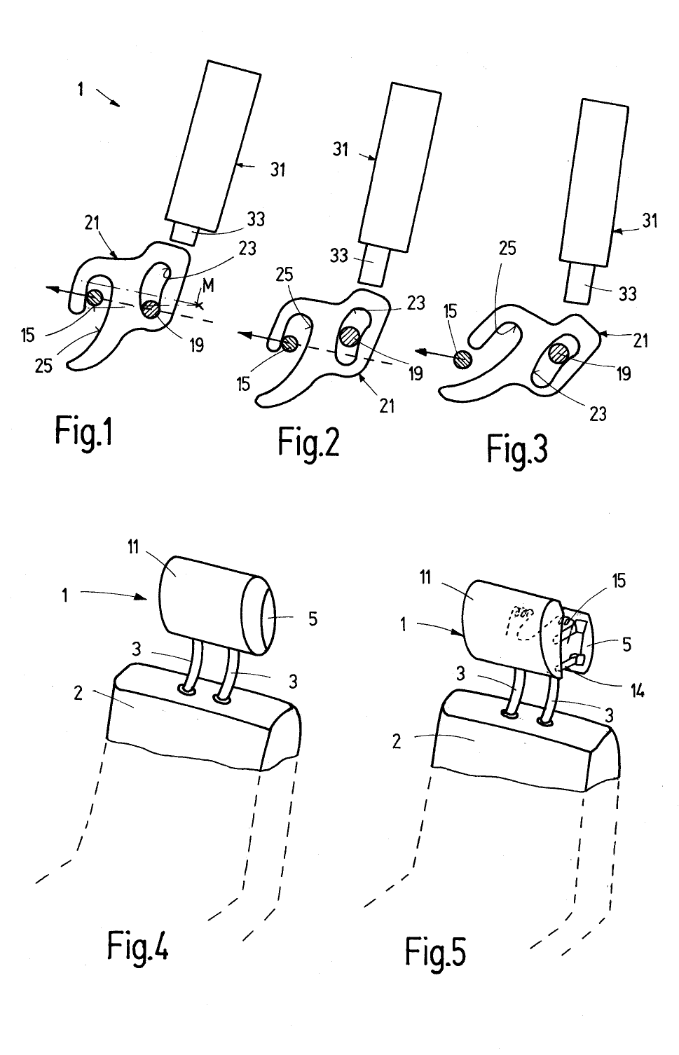

Referring to the drawings in particular, FIG. 1, in both exemplary embodiments, a head restraint 1 is provided as a crash-active system for a vehicle seat 2 of a motor vehicle. The orientation of the same in the vehicle and the customary direction of travel thereof define the directional details used. The basic principle of the head restraint 1 is known from U.S. Pat. No. 7,070,235 B2, the disclosure content of which is expressly incorporated. The head restraint 1 has two head restraint bars 3 which are secured on the vehicle seat 2, or more precisely are mounted at their lower end in the backrest of the vehicle seat 2. For their part, the head restraint bars 3 bear—at their upper end—a support 5 of the head restraint 1, which support is preferably designed as a two-part shell structure. In a modified embodiment, the two head restraint bars 3 can be connected to form a head restraint hoop which is bent in a U-shaped manner.

On the side facing the occupant, the head restraint 1 has an impact element 11. The impact element 11 is coupled to the support 5 on both sides of the support 5 by means of a respective four-bar linkage 14. Each four-bar linkage 14 is formed by the support 5, an upper rocker, the impact element 11 and a lower rocker. The upper rocker and the lower rocker take up an orientation which deviates from parallelism and differ in length. The two lower rockers can be formed separately from each other or integrally with each other. The axes of articulation of the two four-bar linkages 14 are oriented in a transverse direction of the head restraint 1, with the axes of articulation of the one four-bar linkage 14 being aligned with the corresponding axes of articulation of the other four-bar linkage 14.

The head restraint 1 has a drive 15 for the four-bar linkage 14, in the present case a prestressed double leg spring with a central section which is bent in a U-shaped manner and is provided for acting upon the impact element 11, two coil sections, which are designed as helical springs and are received by the support 5, on both sides of the central section and a respective supporting leg, which is supported on the support 5, on that side of each coil section which faces away from the central section. The central section legs which are guided between the impact element 11 and support 5 can serve as upper rockers, as described in DE 10 2004 035 582 B3, the disclosure content of which in this regard is expressly incorporated.

Normally, i.e. apart from in the event of a crash, the impact element 11 is in a retracted starting position, i.e. the four-bar linkages 14 are folded up in such a manner that the impact element 11 is arranged as close as possible to the support 5. In order to hold back the prestressed drive 15, i.e. to prevent it from extending the impact element 11, the drive 15 is locked, in the present case at its central section, to the support 5. In a modified embodiment, the impact element 11 which is acted upon by the drive 15 or another component which is acted upon by the drive 15 can be locked to the support 5.

A latch 21 is mounted in a floating manner on a bearing pin 19 of the support 5, which bearing pin runs in the transverse direction, by the latch 21 surrounding the bearing pin 19 by means of an elongated hole 23. The latch 21 has a hook mouth 25 which receives the drive 15, or more precisely part of the drive 15, in the present case that leg of the central section of the drive 15 which runs in the transverse direction, and therefore locks it. In modified embodiments, the hook mouth 25 receives another component which is acted upon by the drive. In the present case, the hook mouth 25 is open obliquely downward. In the locked state, the latch 21 is arranged in such a manner that the bearing bolt 19 is located at the lower end of the elongated hole 23. The drive 15 lies in the hook mouth 25 in such a manner that it only exerts a closing moment, if any moment at all, on the latch 21, i.e. the reaction force of the latch 21 passes through the bearing pin 19 or runs above it, i.e. counter to the opening direction of the hook mouth 25. The further force and geometrical ratios are described further on in the individual exemplary embodiments.

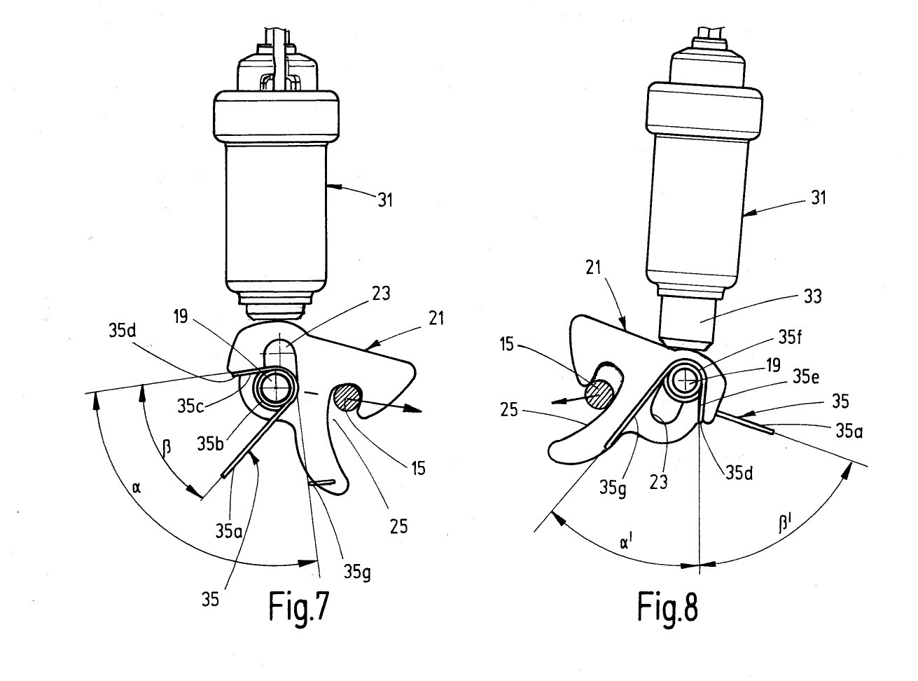

An actuator 31 which has an extendable piston 33 is arranged as an extension of the elongated hole 23. The piston 33 is initially retracted and, in the present case, is aligned with the upper end of the latch 21. The piston 33 either bears against the latch 21 (FIG. 1) in order to support it, or it is spaced apart slightly from the latch 21 (FIGS. 6 and 7). If appropriate, in addition to the actuator 31 mounted on the support 5, a further stop on the support 5 can support the latch 21 and absorb the reaction forces on the drive 15. The bearing pin 19, the actuator 31 and the latch 21 can be entirely or partially arranged within a common housing within the support 5 in order to form a testable unit.

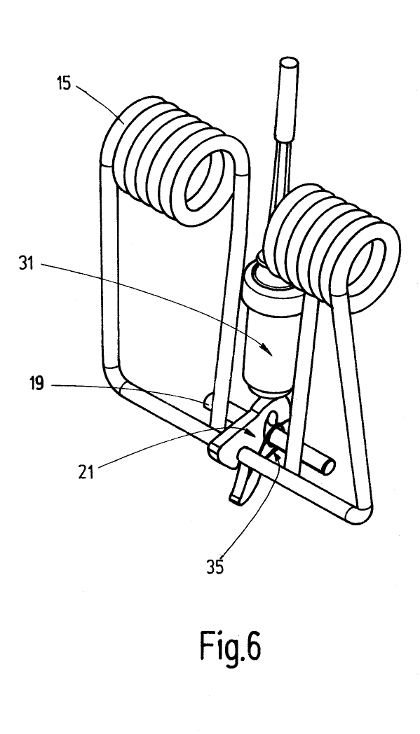

The structure, described up to now, of the head restraint 1 is also upholstered, thereby completing the head restraint 1. Normally, the head restraint 1 forms a compact unit (FIG. 4). In the event of a rear-end crash (or another triggering situation), the actuator is activated by crash sensors or the like, whereupon it extends the piston 33. The actuator 31 may be, for example, a pyrotechnic, magnetic or piezoelectric actuator. The extending piston 33 moves the latch 21 along its elongated hole 23 relative to the bearing pin 19 (FIG. 2). The changes in the force and geometrical ratios are described further on in the individual exemplary embodiments. The latch 21 which is moved by the piston 33 pivots up such that the hook mouth 25 opens in the direction of movement of the drive 15 and releases the drive 15 (FIGS. 3, 8). The impact element 11 now extends—driven by the drive 15—into a protective position situated closer to an occupant's head in order to cushion the latter at an early point (FIG. 5).

To this extent, the two exemplary embodiments correspond. Slight differences emerge in the force and geometrical ratios which are described below.

In the first exemplary embodiment, the drive 15 is in the locked state approximately between the opening of the hook mouth 25 and the base of the hook mouth 25. In order to optimize the geometry of the latch 21, that part of the hook mouth 25 which serves as a bearing surface for the drive 15 is curved in the shape of an arc of a circle about a curvature center point M—offset with respect to the bearing pin 19 in this position—such that the spring force of the drive 15 acts on the latch 21 with the same effective lever arm over the entire tolerance range of the possible positions of the drive 15 in the hook mouth 25, i.e. the system is very substantially insensitive to such tolerances. The piston 33 supports the latch 21.

If, in the event of a crash or another triggering situation, the extending piston 33 displaces the latch 21 along its elongated hole 23 relative to the bearing pin 19, the bearing pin 19 comes to lie approximately in the center of the elongated hole 23 (FIG. 2). The drive 15 now acts along a line which runs next to the bearing pin 19. The moment of the drive 15 now acts in an opening manner on the latch 21. When the latch 21 pivots upward, the bearing pin 19 can pass to that end of the elongated hole 23 which was previously at the top.

In the second exemplary embodiment, the drive 15 received by the latch 21 is located at the base of the hook mouth 25 in the locked state. Tolerances are now compensated for via a rotation of the latch 21 (instead of a displacement between drive 15 and hook mouth 25). The base of the hook mouth 25 is shaped in such a manner that this does not bring about any change in the force ratios, i.e. the drive 15 continues not to exert any opening moment on the latch 21. The surface which faces the piston 33 is curved in the shape of an arc of a circle about the bearing pin 19—which is located at the lower end of the elongated hole 23—such that said rotation of the latch 21 does not have any effect over the entire tolerance range on the ratios at the piston 33, i.e. the system is very substantially insensitive to such tolerances. In the present case, the slight distance between latch 21 and piston 33 remains constant.

If, in the event of a crash or another triggering situation, the extending piston 33 begins to displace the latch 21 along its elongated hole 23 relative to the bearing pin 19, this corresponds to a pivoting movement of the latch 21 about the drive 15 received by the latch 21, i.e. about that part of the drive 15 which is located in the hook mouth 25. The extending piston 33 therefore pivots the latch 21 upward about the drive 15—which serves as the axis of rotation—in order to release the drive 15. In addition, the hook mouth 25 is shaped in such a manner that the contact surface between the drive 15 and the latch 21 changes its inclination as the latch 21 pivots upward. The drive 15 now acts along a line which runs next to the bearing pin 19. The moment of the drive 15 now acts in an opening manner on the latch 21 and therefore assists the pivoting of the latch 21 upward.

A resetting spring 35 is provided to secure the position of the latch 21 in the normal situation. The resetting spring 35, which is formed from a single piece, comprises a plurality of sections which adjoin one another in the sequence described below, namely with a first, outer leg 35a supported on the support 5, a first coil 35b wound around the bearing pin 19 on the one side of the latch 21, a first, inner leg 35c, a connecting leg 35d, which is supported on a step 21a of the latch 21, for example a lug, runs parallel to the bearing pin 19 and leads to the second side of the latch 21, a second, inner leg 35e, a second coil 35f wound around the bearing pin 19 on the second side of the latch 21, and a second, outer leg 35g. The second, outer leg 35g is supported at a point on the latch 21 which is spaced apart from the step 21a, in the present case at a lip on the hook mouth 25.

The first, outer leg 35a, the first coil 35b and the first, inner leg 35c together with the support on the latch 21 by means of the connecting leg 35d have the function of exerting a closing moment on the latch 21. The angle β measured between the first, outer leg 35a and the first, inner leg 35c with regard to the bearing pin 19 increases as the latch 21 pivots upward to an angle β′, i.e. the resetting spring 35 opposes said movement. The drive 15 is thus held at the base of the hook mouth 25.

The second, outer leg 35g, the second coil 35f and the second, inner leg 35e together with the support on the latch 21 by means of the connecting leg 35d have the function of holding the latch 21 in the raised position after the piston 33 has been retracted, i.e. of prestressing the floatingly mounted latch 21 toward one end of its bearing and therefore toward a certain relative position of latch 21 and support 5. The angle α measured between the second, outer leg 35g and the second, inner leg 35e with regard to the bearing pin 19 is reduced as the latch 21 is displaced downward to an angle α′, i.e. the resetting spring 35 opposes said movement. The bearing pin 19 is thus held at the lower end of the elongated hole 23, and therefore, in the present case, the latch 21 is also held in contact with the piston 33 or at a small distance from the piston 33.

In modifications, one or more other means can be provided in order to secure or additionally secure the position of the latch 21 relative to the bearing pin 19 in the normal situation. Such position-securing means may be resilient elements in the elongated hole 23, such as, for example, compression springs or rubber buffers, which cannot press together the latch 21 solely by means of their weight. Spring shackles or supporting elements with predetermined breaking points, which normally additionally support the latch 21 and, in the event of a crash, yield through triggering of the actuator 31 or of the resultant force on the latch 21, are suitable as (additional) position-securing means.

While specific embodiments of the invention have been shown and described in detail to illustrate the application of the principles of the invention, it will be understood that the invention may be embodied otherwise without departing from such principles.

1. A crash-active system of a vehicle, in particular of a vehicle seat, the system comprising:
a support;
an impact element arranged on said support such that said impact element is moveable relative to said support, said impact element being coupled to the support by means of at least one four-bar linkage;
a drive, said drive extending said impact element in the event of a crash from a starting position to a protective position, said impact element being adjacent to said support in said starting position, said impact element being located at a spaced location from said support in said protective position;
a latch for locking the drive to the support, said latch being mounted on the support such that said latch is movable from a locked position to an unlocked position, said latch locking said drive to said support in said locked position.

2. A system as claimed in claim 1, wherein the latch is mounted on the support by means of a bearing pin and an elongated hole.

3. A system as claimed in claim 1, wherein the drive exerts a closing moment on the latch when said latch is in said locked position.

4. A system as claimed in claim 2, wherein, in the event of a crash or another triggering situation, the latch moves relative to a portion of the bearing which is assigned to the support.

5. A system as claimed in claim 4, wherein, in the triggering situation, an actuator, in particular a pyrotechnic, magnetic or piezoelectric actuator, moves the latch.

6. A system as claimed in claim 5, wherein the actuator has a piston which supports the latch or is located at a spaced location from said latch, said piston being in an extended position in the triggering situation such that the latch is moved via said actuator.

7. A system as claimed in claim 4, wherein the drive, with regard to said portion of the bearing of the latch which is assigned to the support, exerts an opening moment on the latch, said latch moving from said locked position to said unlocked position in the triggering situation.

8. A system as claimed in claim 4, wherein the latch pivots in an upward direction in the triggering situation, with the drive received by the latch or a component acted upon by the drive serving as the axis of rotation.

9. A system as claimed in claim 6, wherein the latch receives and holds the drive or a component acted upon by the drive by means of a hook mouth when said latch is in said locked position.

10. A system as claimed in claim 9, wherein the opening latch releases the drive from said hook mouth when said latch is in said unlocked position such that said moves said impact element to said protective position.

11. A system as claimed in claim 9, wherein the latch has an optimized geometry, said hook mouth of the latch having a bearing surface which is curved in the shape of an arc of a circle about a curvature center point for receiving the drive or a component acted upon by the drive, or in that the latch is curved at the contact surface with the piston in the shape of an arc of a circle about the bearing pin.

12. A system as claimed in claim 1, further comprising a resetting spring, said resetting spring being supported on the support, said resetting spring exerting a closing moment on the latch, and/or stressing the latch towards said locking position.

13. A system as claimed in claim 1, wherein the crash-active system is a crash-active head restraint and/or a crash-active antisubmarining ramp.

14. A seat for a motor vehicle, comprising:
a seat structure with a crash-active system, said crash-active system comprising:
a support;
an impact element arranged on said support such that said impact element is moveable relative to said support, said impact element being coupled to said support via at least one four-bar linkage;
a drive, said drive moving said impact element from a starting position to a protective position when the motor vehicle is in a collision, said impact element being located adjacent to said support in said starting position, said impact element being located at a spaced location from said support in said protective position;
a latch for locking the drive to the support, said latch being mounted on the support such that said latch is movable from a locked position to an unlocked position, said latch being in contact with said drive in said locked position such that said drive does not move, said latch not being engaging said drive in said unlocked position.

15. A crash-active system for a vehicle seat of a motor vehicle, the system comprising:
a support element;
a four-bar linkage;
an impact element connected to said support element via said four-bar linkage such that said impact element is moveable relative to said support element;
a driving element connected to said four-bar linkage;
an actuator comprising a piston, said piston being mounted for movement such that said piston moves from a non-extended position to an extended position when the motor vehicle is in a collision;
a latch movably mounted on said support element, said piston engaging said latch in said extended position such that said latch moves from a locked position to an unlocked position, said latch engaging a portion of said driving element in said locked position, said latch releasing said portion of said driving element in said unlocked position such that said driving element moves said impact element from a non-crash position to a crash protective position, said impact element being located adjacent to said support element in said non-crash position, said impact element being located at a spaced location from said support element in said crash protective position.

16. A system as claimed in claim 15, wherein said four-bar linkage is in a folded position when said latch is in said locked position, said driving element moving said four-bar linkage from said folded position to an extended linkage position when said latch is in said unlocked position.

17. A system as claimed in claim 15, further comprising a bearing pin, said latch comprising an elongated hole, said elongated hole receiving said bearing pin, said bearing pin engaging a first end of said elongated hole when said latch is in said locked position, said bearing pin engaging a second end of said elongated hole when said latch is in said unlocked position, said first end of said elongated hole being disposed opposite said second end of said elongated hole.

18. A system as claimed in claim 15, wherein said latch comprises a hook mouth having a bearing surface which is curved in the shape of an arc of a circle about a curvature center point, said bearing surface engaging said portion of said driving element when said latch is in said locked position.

19. A system as claimed in claim 18, wherein said bearing surface is not in contact with said driving element when said latch is in said unlocked position.

20. A system as claimed in claim 15, further comprising a resetting spring, said resetting spring being supported on said support element, said resetting spring being in a compressed state when said latch is in said locked position.
